(19) United States
(12) Patent Application Publication
(10) Pub. No.: US 2013/0053486 A1
(43) Pub. Date: Feb. 28, 2013

(54) SEALANT MATERIALS AND METHODS OF USING THEREOF

(71) Applicant: William V. Dower, Austin, TX (US)

(72) Inventor: William V. Dower, Austin, TX (US)

(73) Assignee: 3M Innovative Properties Company

(21) Appl. No.: 13/570,307

(22) Filed: Aug. 9, 2012

Related U.S. Application Data
(60) Provisional application No. 61/528,519, filed on Aug. 29, 2011.

(51) Int. Cl. C08K 5/1545

(52) U.S. Cl. 524/110

(57) ABSTRACT

The present invention is a composition for a gel sealant material. The exemplary gel sealant material composition includes mineral oil, a thermoplastic elastomer and a vitamin E based antioxidant. In particular, the gel sealant material composition comprises 79-95 parts by weight of a mineral oil, 5-20 parts by weight of a thermoplastic elastomer and 0.05-1 part by weight of a vitamin E based antioxidant. In one exemplary aspect, the vitamin E based antioxidant is one of a tocopherol and a tocotrienol.

### CROSS REFERENCE TO RELATED APPLICATION

This application claims the benefit of U.S. Provisional Patent Application No. 61/528519, filed Aug. 29, 2011, the disclosure of which is incorporated by reference herein in its entirety.

### FIELD OF THE INVENTION

The present invention relates to sealant materials for use in connection points. In particular, the present invention relates to sealant material comprising one of a tocopherol and tocotrienol based antioxidant for protecting communication cables and other connections against environmental conditions.

### BACKGROUND OF THE INVENTION

Communication cables, such as electrical and optical cables, are used in a variety of environmental conditions. For example, communication cables may be placed in humid environments or buried underground. In such applications, the communication cable needs to withstand water penetration whenever the cable jacket is opened because water can severely affect the performance of the cable. For example, in an electrical cable, water may destroy the capacitance balance of the electrical conductor, short circuit the electrical cable, and induce high resistance due to corrosion. In coaxial cables used to connect antennas in wireless cell phone tower installations, corrosion can induce Passive Intermodulation (PIM) which causes interference, unwanted spurious signal, and loss. Similarly, in an optical cable, water may negatively affect the integrity of the optical fibers contained within the cable. The effects of moisture are particularly problematic at connection points of communication cables (e.g., cable boxes and connectors), where the communication cables are generally more vulnerable to moisture exposure.

One solution to minimize water penetration at a connection point involves encasing the communication cables at the connection point, and surrounding the connection point with a water insoluble material, such as greases, encapsulants or gel sealing materials. Greases generally seal the connection point and stop the migration of water, but can be costly in cases where it is necessary to fill a large volume and can be messy to work with. Typical encapsulant materials are generally two part reactive systems which must be mixed at the time connections are made.

Gels are used to seal electrical connections, and provide environments which are protected against the entry of water and dirt. Typical gels include oil-filled thermoplastic elastomeric rubbers (e.g. diblock or triblock copolymers such as styrene/rubber and styrene/rubber/styrene block copolymers), RTV and thermoset compositions, (e.g. silicones, epoxy, urethane/isocyanates, esters, etc.), and radiation cured materials including e-beam and UV/Vis radiation sensitive formulations. These materials historically provide a physical block to the migration of water into regions protected by the oil gel.

Degradation of thermoplastic elastomeric rubbers of the gel material after prolonged exposure to elevated temperatures can result in a decrease in physical properties. To help slow this degradation, antioxidants such as Irganox 1010 are typically added to the formulation to help stabilize the gel. However, the degradation in the final properties of the oil gel still occurs.

Thus, a better antioxidant is needed to prevent degradation in thermoplastic elastomeric rubbers in oil based gel sealing materials and improve the thermal stability of the gel sealing material.

### SUMMARY OF THE INVENTION

The present invention is a gel sealant material that includes mineral oil, a thermoplastic elastomer and a vitamin E based antioxidant. In particular, the gel sealant material composition comprises 79-95 parts by weight of a mineral oil, 5-20 parts by weight of a thermoplastic elastomer and 0.05-1 part by weight of a vitamin E based antioxidant. In one exemplary aspect, the vitamin E based antioxidant is one of a tocopherol and a tocotrienol. In another exemplary aspect, the thermoplastic elastomer is a styrenic block copolymer.

The exemplary gel sealant material described herein can be used to protect at least one cable connection from environmental contamination, albeit, moisture dust, insects or other contaminant. In particular the exemplary gel sealant material can be used in a telecommunications module located in a closure, pedestal, or cabinet in an outside plant telecommunication network. Alternatively, the exemplary gel sealant material can be used in a telecommunication enclosure to protect a connection between a cable and a housing or piece of equipment or to protect a connection between at least two telecommunication cables.

Objects and advantages of this disclosure are further illustrated by the following non-limiting examples. In particular, the materials and amount thereof as well as the conditions and other details should not be construed to unduly limit the disclosure, but are rather intended as illustrative examples to show the utility and advantages of the exemplary gel sealant materials.

References to a singular compound or composition includes both the singular and plural forms. For, example, the term “thermoplastic elastomer” can refer to a single thermoplastic elastomer or a mixture of two or more thermoplastic elastomers. Similarly, the term “block copolymer” can refer to a single block copolymer such as a styrenic triblock copolymer or a mixture of two or more block copolymers such as a mixture of a triblock copolymer and a diblock copolymer.

### BRIEF DESCRIPTION OF THE DRAWINGS

The present invention will be further described with reference to the accompanying drawings, wherein:

FIG. 1 is a graph showing the oxidative stability of an exemplary gel sealant material containing 0.2% of a tocopherol antioxidant.

FIG. 2 is a graph showing the oxidative stability of an exemplary gel sealant material containing 0.5% of a tocopherol antioxidant.

FIG. 3 is a graph showing the oxidative stability of a gel sealant material containing 0.2% of a conventional antioxidant.

FIG. 4 is a graph showing the oxidative stability of a gel sealant material containing 0.5% of a conventional antioxidant.

FIG. 5 is a graph showing the degradation of the block copolymer in an exemplary gel sealant material containing 0.5% of a tocopherol antioxidant.

FIG. 6 is a graph showing the degradation of the block copolymer in an exemplary gel sealant material containing 0.5% of a conventional antioxidant.

While the invention is amenable to various modifications and alternative forms, specifics thereof have been shown by way of examples and information provided in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

Conventional gel sealant materials are used to seal electrical connections, and provide environments which are protected against the entry of water and dirt. Typical gel sealant materials can be oil swollen, cross-linked polymer network. The cross-links can be either due to physical association or chemicals bonds formed between the polymer chains within the network. Exemplary oil swollen gel materials can include oil-filled thermoplastic elastomeric rubbers (e.g. styrene/rubber/styrene block copolymers), RTV and thermoset compositions, (e.g. silicones, epoxy, urethane/isocyanates, esters, etc.), and radiation cured materials including e-beam and UV/Vis radiation sensitive formulations.

The present invention is directed to an environmental sealant material with improved thermal stability. The exemplary gel sealant materials described herein may be used in a telecommunication enclosure or connector to protect a connection between two or more cables, a telecommunication enclosure to protect a connection between a cable and a housing or piece of equipment, or in an outside plant cross connection module.

Exemplary gel sealant materials can include soft thermoplastic elastomers which have been melted/dissolved in white mineral oils and allowed to cool. The soft thermoplastic elastomers can be conveniently made from block copolymers with rubber mid-blocks and styrene end blocks. The exemplary gel sealant materials should withstand compression set at temperatures 50° C.-75° C. or above. The ability of the gel sealant materials to withstand this type of compression set is determined in large part by the selection of the thermoplastic elastomers, oils, and additives as well as their respective loading levels and processing conditions. Improving compression set behavior of the gel sealant material may necessitate higher processing temperatures, in some cases at or above 225° C., both for preparing the gel sealant material as well as dispensing the gel sealant material. Exposure to these high processing temperatures causes degradation of the thermoplastic elastomer(s), particularly in the presence of oxygen. The degradation of the thermoplastic elastomer(s) can cause a change in mechanical properties including lower modulus, higher surface tack, and loss of compression set resistance.

To mitigate this degradation, antioxidants such as Irganox 1010 have been used in oil gel sealant materials. However, at these higher temperatures even in the presence of the antioxidants, the working time is short before degradation is noted. Other antioxidants including sulfur-containing formulations like Irganox 1520L are better than Irganox 1010 at delaying the onset of decomposition of the polymers, but these typically produce objectionable odors at high processing temperatures. Additionally, the functionality required to provide antioxidant performance often results in a higher polarity than standard to hydrocarbon-only structures, and higher polarity antioxidants show poor solubility in low polarity mineral oils. Even at loadings below 0.2%, the higher polarity/lower solubility antioxidants can phase separate from the oil gel sealant material. This phase separation can result in the formation of crystals which can interfere with the texture of the gel sealant material at some point of time after the gel sealant material has cooled to form a gel.

A preferred antioxidant for these gel sealant formulations is a liquid or a low melting temperature solid, with low polarity for good solubility, and a temperature/activity curve matched to the high processing temperatures of these materials.

Compositions according to the present disclosure form gel sealant materials. Exemplary gel sealant materials can comprise 79 to 95 parts by weight of mineral oil, 5 to 20 parts by weight of thermoplastic elastomer and 0.05 to 1 part of a tocopherol or tocotrienol based antioxidant. Vitamin E (alpha tocopherol) is a highly effective antioxidant for use in telecommunication applications, and has low toxicity as an added benefit.

The term mineral oil, as used herein, refers to any of various light hydrocarbon oils, especially distillates of petroleum. Typically, the mineral oil is a white mineral oil although other mineral oils may be used. White mineral oils are generally colorless, odorless or nearly odorless, and tasteless mixtures of saturated paraffinic and naphthenic hydrocarbons that span a viscosity range of 50-650 Saybolt Universal Seconds (5 to 132 centistokes) at 100° F. (38° C.). Nearly chemically inert, white mineral oils are essentially free of nitrogen, sulfur, oxygen and aromatic hydrocarbons. Exemplary mineral oils include KAYDOL oil available from Crompton Corporation (Middlebury, Conn.), DuoPrime 350 and DuoPrime 500 available from Citgo Petroleum Corporation (Houston, Tex.), Crystal Plus 200T and Crystal Plus 500T available from STE Oil Company, Inc. (San Marcos, Tex.). Typically, 70 to 95 parts by weight of mineral oil, or even more typically 85 to 93 parts by weight of mineral oil are used in combination with 7 to 15 parts by weight of the at least one thermoplastic elastomer and 0.05 to 1 part of a tocopherol or tocotrienol based antioxidant.

In an alternative embodiment, the mineral oil can be replaced fully or in part by another petroleum based oil, a vegetable oil or a modified version of either of these two oil types.

Suitable thermoplastic elastomers for use in sealant material include styrene-rubber-styrene (SRS) triblock copolymers, styrene-rubber-styrene (SRS) diblock copolymers, styrene-rubber-styrene (SRS) star copolymers or mixtures thereof. Exemplary styrene-rubber-styrene triblock copolymers include styrene-butadiene-styrene (SBS), styrene-isoprene-styrene (SIS), and partially or completely hydrogenated derivatives thereof, such as styrene-ethylene/butylene-styrene (SEBS), styrene-ethylene/propylene-styrene (SEPS), styrene-ethylene/ethylene/propylene-styrene (SEEPS), and combinations thereof. Examples of commercially available suitable SEBS block copolymers for use in the exemplary sealant material include trade designated “KRATON G-1651” and “KRATON G-1633” Block Copolymers, both of which are commercially available from Kraton Polymers (Houston, Tex.). Examples of commercially available suitable SR diblock copolymers include trade designated “KRATON G-1701” and “KRATON G-1702” Block Copolymers, both of which are commercially available from Kraton Polymers (Houston, Tex.), and “SEPTON S 1020” High Performance Thermoplastic Rubber, which is commercially available from Kuraray Company (Tokyo, Japan). Exemplary suitable SEPS and SEEPS block copolymers for use in the exemplary sealant material include trade designated “SEPTON S 4055” or “SEPTON S 4077” High Performance Thermoplastic Rubber which are commercially available from Kuraray Company (Tokyo, Japan). An exemplary SRS star copolymer is “SEPTON KL-J3341”, also available from Kuraray Company (Tokyo, Japan). Additionally, suitable vinyl-rich block copolymers for use in the exemplary sealant material include “HYBRAR 7125” and “HYBRAR 7311” High Performance Thermoplastic Rubbers, which are also commercially available from Kuraray Company (Tokyo, Japan). A suitable maximum concentration of the block copolymer in the gel sealant material is about 30% by weight, based on the entire weight of gel sealant material.

Suitable stabilizers and antioxidants include tocopherols or tocotrienols and combinations thereof. Tocopherols or tocotrienols are fat soluable antioxidants. The antioxidant activity arises from the molecules' ability to donate a hydrogen atom from the hydroxyl group on the aromatic ring, to a free radical on another molecule which quenches the free radical. The hydrophobic side chains of these molecules provide a lower polarity and a preferred higher solubility in the oil and rubber phase, which make them especially useful for use in the exemplary gel sealant materials described in the present disclosure. The improved solubility lowers the threshold for phase separation and decreases any tendency to partition into the nanodispersed polystyrene phase. Tocopherols are a series of organic methylated phenol compounds. For example, alpha tocopherol (M.W. 430.71 g/mol) can be represented by the following chemical structure:

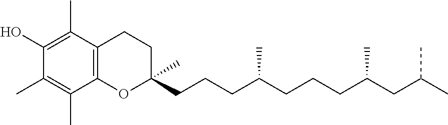

Tocotrienol (M.W. 424.66 g/mol) is an analog of tocopherol having an unsaturated side chain and can be represented by the following chemical structure wherein R1, R2 and R3 may be a hydrogen atom or a methyl group:

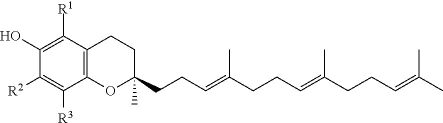

An exemplary commercially available tocopherol-based antioxidant includes α-tochopherol, commercially available from Sigma-Aldritch (St. Louis, Mo.). A suitable maximum concentration of stabilizers or antioxidants in the gel sealant material is about 0.1% to about 1% by weight, based on the entire weight of the gel sealant material. When forming the gel sealant material, the antioxidants may be dissolved or dispersed in the mineral oil prior to combining the diblock copolymer with the mineral oil.

Other additives which may be added to the exemplary gel sealing material of the current invention can include cure catalysts, biocides, colorants, thermally conductive fillers, etc.

### EXAMPLES

The present invention is more particularly described in the following examples that are intended as illustrations only, since numerous modifications and variations within the scope of the present invention will be apparent to those skilled in the art. Unless otherwise noted, all parts, percentages, and ratios reported in the following examples are on a weight basis, and all reagents used in the examples were obtained, or are available, from the chemical suppliers described below, or may be synthesized by conventional techniques.

Materials Used

Kraton G1651: A styrene-rubber-styrene triblock copolymer (i.e. a thermoplastic elastomer) commercially available under the trade designation “KRATON G1651” Block Copolymer available from Kraton Polymers (Houston, Tex.).

Mineral oil: commercially available under the trade designation “Duoprime 500” available from Citgo Petroleum Corporation (Houston, Tex.).

Vitamin E: alpha tocopherol commercially available under the trade designation “α-tocopherol” available from Sigma-Aldrich (St. Louis, Mo.).

Irganox 1010: Pentaerythritoltetrakis(3-(3,5-di-tert-butyl-4-hydroxyphenyl)propionate) is commercially available from BASF The Chemical Company (Freeport, Tex.).

Sealant materials of Examples 1 and 2 and Comparative Examples 1 and 2 were prepared pursuant to the following procedure. Table 1 provides the weight percent concentrations of the components for the sealant materials of Examples 1 and 2 and Comparative Examples 1 and 2.

The antioxidant was dispersed in the mineral oil and then added to the thermoplastic elastomer and allowed to sit at room temperature overnight. The elastomer oil mixture was then heated to 230° C. with continuous stirring in a closed vessel until fully melted and uniform.

The formulated gel sealant could be cooled at this stage to gel.

TABLE 1

| | | | Comparison | Comparison |
|---|---|---|---|---|
| Components | Ex. 1 | Ex. 2 | Ex. 1 | Ex. 1 |
| Mineral oil | 90.8 | 90.5 | 90.8 | 90.5 |
| Kraton G 1651 | 9.0 | 9.0 | 9.0 | 9.0 |
| Alpha tocopherol | 0.2 | 0.5 | 0.0 | 0.0 |
| Irgacure 1010 | 0.0 | 0.0 | 0.2 | 0.5 |
| Total | 100.0 | 100.0 | 100.0 | 100.0 |

To test the oxidative stability of the formulations, the vessel containing the hot melted gel sealant material is opened, allowing air to be charged to the vessel. Enough material is removed from the vessel to make 3 sample disks of the material. The sample disks were cast in copper rings to yield 8.4 mm high by 19 mm in diameter samples upon cooling. The container was then resealed and allowed to continue heating with continuous stirring. Sample removal was repeated at 5 minute intervals over a period of 30 minutes. At each interval the container was re-opened and exposed to air (i.e. oxygen).

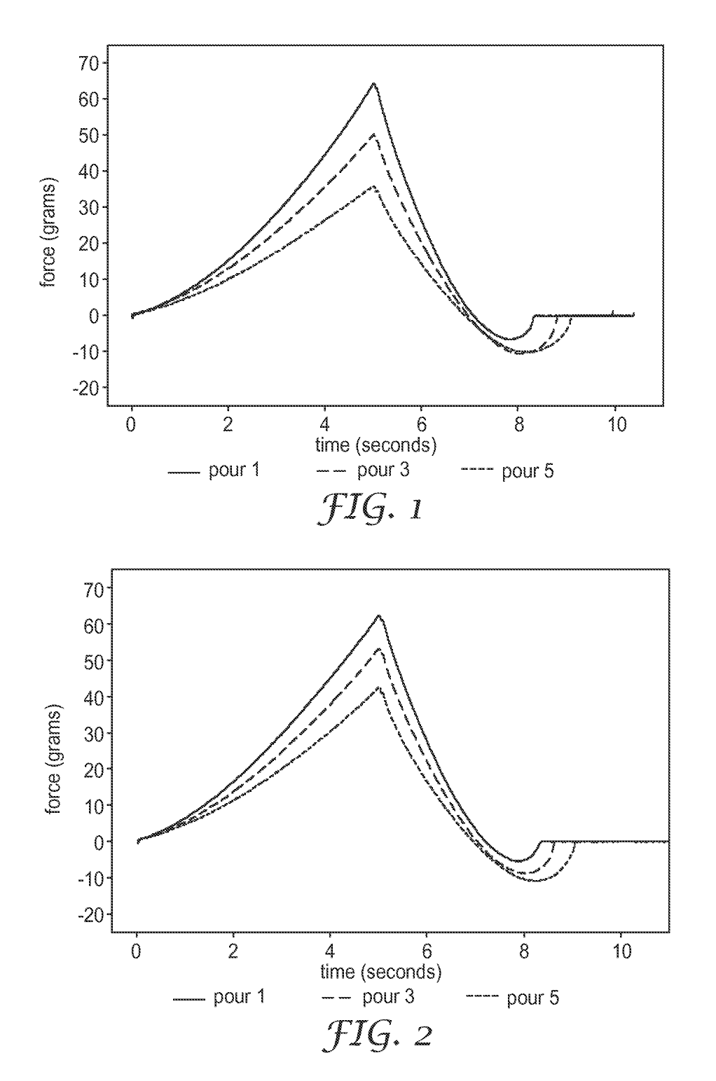

After allowing the samples to cool completely, each of the samples was tested using a Texture Analyzer available from Texture Technologies (Scarsdale, N.Y.) fitted with a 1/4 in. stainless steel ball probe. The texture analyzer pushed the probe into the sample at a speed of 1.0 mm/sec while monitoring the force. The probe was allowed to penetrate 5 mm or approximately 60% of the thickness of the sample. The probe was then withdrawn at a speed of 1.0 mm/sec while measuring the force required to extract the probe from the sample. The data is plotted as the force exerted on the probe as a function of time which can be directly related to the depth of penetration of the probe into the gel sealant material. The graphs shown in FIGS. 1-4 show the force exerted on the 1/4 in. ball probe by the sample of thermoplastic elastomer oil gel sealant as the Y axis, and the X axis shows the time elapsed since contact was detected by the probe. The position of the probe within the gel sample can be calculated as a product of the speed and the time, because the probe moves at a constant speed (with the exception of the point where the probe changes direction, which occurs 5 sec. after contacting the surface of the gel sealant samples and is the point of maximum force). The graphs were plotted as a function of time rather than distance, because plotting against distance as the X axis would result in the curves doubling back on themselves, causing confusion about which portion of the curve indicates the penetration of the probe and which portion indicates the withdrawal of the probe from the gel sealant sample.

FIG. 1 shows the results of the oxidative stability analysis for the Example 1 formulation which includes 0.2% of the tocopherol antioxidant. The graph shows the first sample removed from reaction vessel (pour 1), i.e., the nearly pristine material as indicated by the solid line. The dashed line indicates samples removed after two oxygen introduction cycles (pour 3) and the dotted line indicates the sample taken after four oxygen introduction cycles (pour 5). The graph shows a decrease in modulus of the exemplary gel sealant material as the degree of oxidative damage of the thermoplastic elastomer increases as indicated by the reduction in the heights of the peaks in the graph. The position of the peak maximum decreases as the sample degrades indicating that the probe experiences less resistance by the sample as it is pushed into the sample. In addition the test shows that the sample becomes tackier as the amount of oxidative degradation increases as shown by the position of the force minimum (i.e. the depression in the curve just prior to release of the probe from the sample) as it shifts to the right and increases in depth (becomes more negative) as the sample degrades, during the process of withdrawing the probe from the sample.

FIG. 2 shows the results of the oxidative stability analysis for the Example 2 formulation which includes 0.5% of the tocopherol antioxidant. Much less degradation is seen in the height of the force curve and a smaller increase in depth of the force minimum indicating that the thermoplastic elastomer in this formulation undergoes a lesser degree of oxidative degradation than the formulation containing the 0.2% tocopherol.

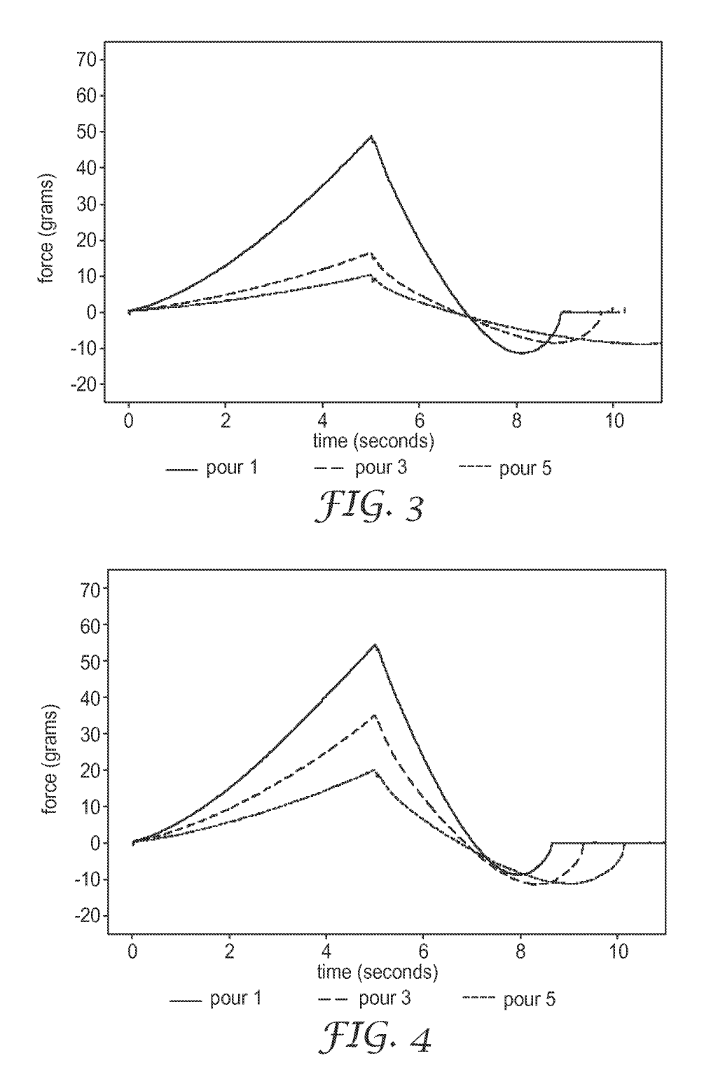

FIGS. 3 and 4 show the results of the oxidative stability analysis for the Comparative Examples 1 and 2 formulation which includes 0.2% and 0.5% of the conventional Irganox 1010 antioxidant, respectively. The degree of degradation of the thermoplastic elastomer is much greater in the samples with the Irganox 1010 antioxidant than was seen in the samples with the tocopherol antioxidant.

It has long been recognized that “The terminal chains [those lying between the end of a polymer chain and the first crosslinking point], unlike the internal chains . . . are subject to no permanent restraint by deformation; their configurations may be temporarily altered during the deformation process, but rearrangements proceeding from the unattached chain ends will in time restore them to a random state”, as described by Paul Flory (p. 461 of Principles of Polymer Chemistry, Cornell University Press, 1953).

FIGS. 1-4 illustrate this degradation behavior. The exposure to oxygen at the elevated processing temperatures for the exemplary gel sealant material and comparative example material described herein can result in or promote chain scission of the triblock styrene/rubber/styrene rubber polymer contained in the respective formulations. The block copolymer can be broken any place in the central rubber segment of the polymer chain. This breakage will convert an elastic cross-linking segment (which contributes to the elastic recovery of a deformed solid) into two terminal chains, which do not contribute to the elastic recovery of a deformed solid.

While the broken chains do not contribute to restoration force, they do contribute viscosity and surface tack, and this can also be seen in the change in the shape of the force curves after withdrawal from the original point of contact, with the weaker force constant always showing higher tack and elongation during withdrawal as shown by the depression in the curves of the samples which had more exposure to oxygen.

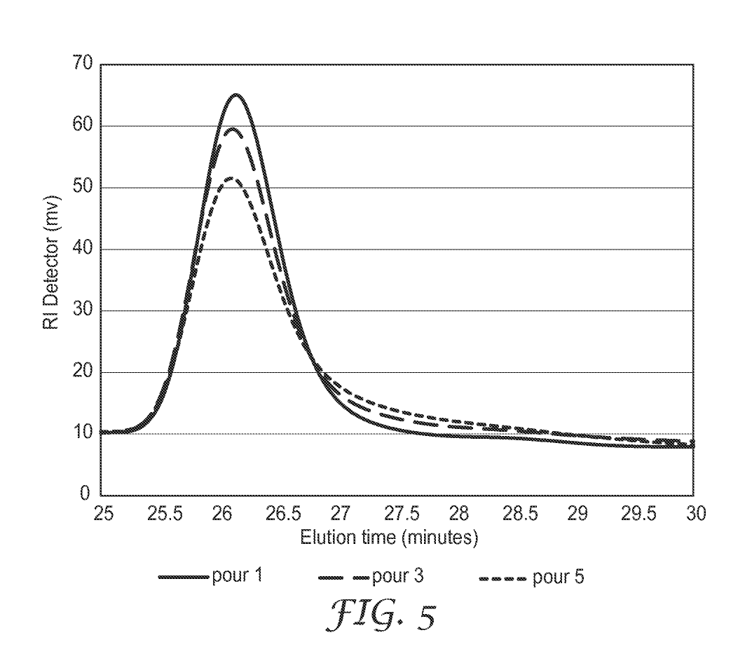

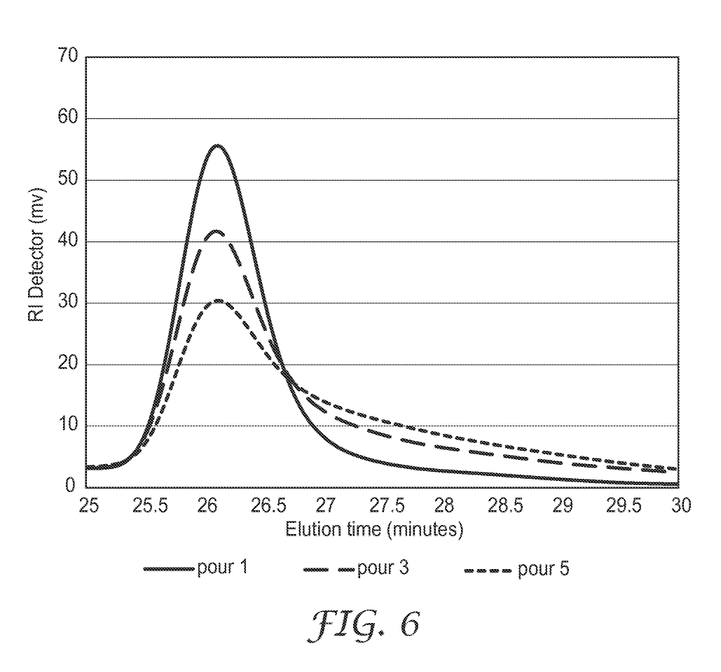

The degradation of the block copolymer chain was confirmed using a standard gel permeation chromatography (GPC) technique. GPC is a size exclusion process in which the larger molecular weight components of a mixture experience a smaller effective column volume, and thus exit the chromatographic process more quickly (i.e. have a lower elution time). In addition, the output of the GPC provides insight into the molecular weight distribution of the polymer passing through the GPC. A narrow peak is indicative of a narrow molecular weight distribution, while a wider peak indicates a broader molecular weight distribution. The elution time and intensity of the detector signal will depend on the column, the flow rate, the solvent, the concentration and injection volume of the sample, and a number of other variables. As a result, each sample must be compared to a standard, and all samples being compared must be run at the same conditions. For the GPC curves shown in FIGS. 5 and 6, the same chromatographic conditions were maintained for all the samples measured.

The curves in FIGS. 5 and 6 show that the average molecular weight of the block copolymer is decreasing with longer exposure to hot oxygen comparing the nearly pristine samples of pour 1 in both graphs to the samples having more exposure to oxygen (i.e. pours 3 and 5). In addition the broadening of the peaks indicates that the molecular weight distribution of the block copolymer is broadening. These results are consistent with the polymer chains being broken and the fragments forming lower molecular weight units having much less uniformity of molecular weight. Comparison between the 0.5% vitamin E sample (Example 2, FIG. 5) and the 0.5% Irganox 1010 sample (Comparative Example 2, FIG. 6) show that while the initial curve (pour 1) is similar in both materials, that the degradation of the block copolymer is significantly more noticeable for the Irganox 1010 sample in comparison to the vitamin E sample.

Various modifications and alterations of this disclosure may be made by those skilled in the art without departing from the scope and spirit of this disclosure, and it should be understood that this disclosure is not to be unduly limited to the illustrative embodiments set forth herein.

What is claimed is:

1. A gel sealant material composition comprising:
79 to 95 parts by weight of a mineral oil, 5 to 20 parts by weight of a thermoplastic elastomer and 0.05 to 1 part by weight of a vitamin E based antioxidant.

2. The composition of claim 1, wherein the vitamin E based antioxidant is one of a tocopherol and a tocotrienol.

3. The composition of claim 1, wherein the vitamin E based antioxidant is alpha-tocopherol.

4. The sealant composition of claim 1, wherein the thermoplastic elastomer comprises a styrenic block copolymer.

5. The sealant composition of claim 1, wherein the thermoplastic elastomer comprises at least one of a diblock copolymer, a triblock copolymer or a star copolymer.

6. The gel sealant material sealant composition of claim 1, wherein the gel sealant material sealant composition forms an oil swollen, cross-linked polymer network.

7. Use of the composition of claim 1 as a gel sealant material for protecting at least one cable connection.

8. Use of the composition of claim 1 as a gel sealant material in a telecommunications cross-connection module.

9. Use of the composition of claim 1 as a gel sealant material in a telecommunication enclosure to protect a connection between a cable and a housing or piece of equipment.

10. Use of the composition of claim 1 as a gel sealant material in a telecommunication enclosure to protect a connection between at least two telecommunication cables.
